(19) United States
(12) Patent Application Publication
(10) Pub. No.: US 2019/0126447 A1
(43) Pub. Date: May 2, 2019

(54) ROTARY TORQUE BOOSTING DEVICE

(71) Applicant: CHINA PNEUMATIC CORPORATION, Taoyuan city (TW)

(72) Inventor: YU-WEI CHU, TAOYUAN CITY (TW)

(21) Appl. No.: 15/797,103

(22) Filed: Oct. 30, 2017

(51) Int. Cl. B25B 21/02; B25D 11/04; B25D 11/10

(52) U.S. Cl. CPC B25B 21/023; B25D 11/104; B25D 11/04

(57) ABSTRACT

The rotary torque boosting device includes a main body with an inertia flange to be assembled or made as one piece structure with the main body, an input member having an input recess for receiving the anvil of the impact wrench, an output recess for receiving a detachable driving anvil made to accommodate the impact socket with the same driving head type and dimension which to be secured with a retaining device for easy replacement, such as a magnet unit adhered at the bottom of the recess or an inner retaining groove by the side for receiving the ball retainer or a retaining ring on the driving anvil. The rotary torque boosting device will solve the drawback of the prior art especially the driving anvil will not be held durable enough under the magnified torque induced by the inertia effect during operation.

### FIELD OF THE INVENTION

The present invention relates to a rotary torque boosting device, and more particularly, to a rotary torque boosting device including a driving anvil that can be easily replaced and manufactured using steel materials of different strengths to bear differently magnified torques, and can therefore effectively extend the service life of the rotary torque boosting device.

### BACKGROUND OF THE INVENTION

A prior art rotary torque boosting device as shown in FIG. 1, which is also invented by the same inventor of the present invention, can effectively boost the output torque of a power impact tool to tighten or loosen screws or bolts, and can be used with differently sized sockets to largely lower the cost of purchasing power impact tools. However, in practical application of the prior art rotary torque boosting device, the output member of the main body 31 thereof tends to break when bearing an extremely high rotary torque.

FIGS. 2A and 2B show stress analysis conducted on the prior art rotary torque boosting device of FIG. 1. When the main body 31 is subjected to a torque of 400 Nm, the factor of safety (FoS) of the main body 31 is as high as 1.0. However, when the main body 31 has a disc exterior inertia member 30 assembled thereto and is subjected to an output torque up to 680 Nm, the FoS of the main body 31 is lowered to only 0.62. FIG. 3 shows another stress analysis conducted on the same rotary torque boosting device but including a main body 31 manufactured using a special high-strength steel material, such as C350 maraging steel, and having a disc exterior inertia member 30 assembled thereto. As shown, the FoS of this main body 31 is 1.1 when it is subjected to a boosted torque up to 680 Nm. Therefore, from these stress analysis, it can be found the main body 31 must be manufactured using improved material to safely bear a magnified torque produced by the disc exterior inertia member 30. However, the use of a high-strength steel material to manufacture the main body 31 will increase the manufacturing cost of the rotary torque boosting device and forms a big hindrance to the commercialization of the rotary torque boosting device. Therefore, it is not recommended using a main body made of a high-strength steel material. Under this circumstance, it is tried by the inventor to develop an improved rotary torque boosting device that includes a driving anvil manufactured using a steel material with higher strength for easily removably connecting to a variety of differently sized sockets at hand, so that the improved rotary torque boosting device can still include a main body selectively usable with removable disc exterior inertia members of different rotary inertia without increasing too much manufacturing cost of the entire rotary torque boosting device or increasing the quantity of different parts in stock. With these advantages, the improved rotary torque boosting device of the present invention is more practical for use and can be more easily commercialized,

### SUMMARY OF THE INVENTION

A primary object of the present invention is to effectively overcomes the drawbacks of the prior art rotary torque boosting device by providing an improved rotary torque boosting device including a driving anvil, which is elastically and removably assembled to an output member of a main body for easy replacement thereof and can be manufactured using steel materials of different strengths. With these arrangements, the rotary torque boosting device of the present invention can have largely increased structural strength and factor of safety without increasing too much manufacturing cost thereof.

To achieve the above and other objects, the rotary torque boosting device according to the present invention includes a main body and a driving anvil. The main body includes an inertia flange, an input member and an output member. The inertia flange can be selectively assembled to or integrally formed with the main body. The input member of the main body is connectable to an output member of a power impact tool; and the output member of the main body has an output recess. The driving anvil is selectively fitted in the output recess of the output member of the main body to be conveniently removable from the output recess for replacement, and can be manufactured to match sizes and shapes of different sockets to be connected thereto. Therefore, the rotary torque boosting device of the present invention can be flexibly, economically and effectively used in bolt tightening and loosening operations with a magnified rotary torque.

In the rotary torque boosting device of the present invention, the input member of the main body can be differently sized and shaped to match those output member of the power impact tool to be used therewith.

In the rotary torque boosting device of the present invention, the output recess of the output member of the main body can be differently sized and shaped to match those of the driving anvil to be fitted therein.

In the rotary torque boosting device of the present invention, the driving anvil is manufactured using a high-strength steel material selected according to a magnitude of torque that can be magnified by the inertia flange, and can be differently sized and shaped to match sizes and shapes of the sockets to be used therewith; and wherein the driving anvil is assembled to the main body and coaxial with the inertia flange.

In the rotary torque boosting device of the present invention, the inertia flange can be selectively coaxially assembled to or integrally formed with the main body.

In the rotary torque boosting device of the present invention, the inertia flange, the main body and the driving anvil can be integrally coaxially formed with one another.

In the rotary torque boosting device of the present invention, the driving anvil is provided with at least one elastic retaining device or spring-supported ball retainer to ensure that the driving anvil is stably held to the position inserted in the output member of the main body and can be easily replaced.

In the rotary torque boosting device of the present invention, a magnetic unit can be bonded to the inner bottom of the output recess of the output member of the main body to magnetically attract the driving anvil thereto while allowing easy removal of the driving anvil from the main body for replacement.

With the above arrangements, the rotary torque boosting device of the present invention includes a driving anvil conveniently replaceable connected to the main body and can therefore overcome the problem that the output member of the main body of the prior art rotary torque boosting device tends to break during operation when bearing a high rotary torque. With the replaceable driving anvil, the rotary torque boosting device of the present invention can be more flexible, economically and effectively used in the bolt tightening and loosening operation.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows exploded cutaway view, assembled top and bottom cutaway views, and assembled sectional view of a prior art rotary torque boosting device;

FIG. 2A shows stress analyses conducted on a main body of the prior art rotary torque boosting device of FIG. 1 before and after the same is subjected to a magnified torque;

FIG. 2B shows stress analyses conducted on a main body of the prior art rotary torque boosting device of FIG. 1 before and after the same is subjected to a magnified torque;

FIG. 3 shows a stress analysis conducted on a main body of another conventional rotary torque boosting device that is manufactured using a special high-strength steel material;

FIG. 4 shows assembled sectional view and exploded cutaway view of an improved rotary torque boosting device according to a preferred embodiment of the present invention;

FIG. 5A shows stress analyses conducted on a structured driving anvil for the rotary torque boosting device of FIG. 4 when the driving anvils are respectively subjected to a magnified torque;

FIG. 5B shows stress analyses conducted on a structured driving anvil for the rotary torque boosting device of FIG. 4 when the driving anvils are respectively subjected to a magnified torque;

FIG. 5C shows stress analyses conducted on a structured driving anvil for the rotary torque boosting device of FIG. 4 when the driving anvils are respectively subjected to a magnified torque; and

FIG. 6 shows perspective, cross sectional and longitudinal sectional views of the rotary torque boosting device of the present invention according to another embodiment thereof.

### DETAILED DESCRIPTION OF THE PREFERRED EMBODIMENTS

The present invention will now be described with some preferred embodiments thereof and by referring to the accompanying drawings. For the purpose of easy to understand, elements that are the same in the preferred embodiments are denoted by the same reference numerals.

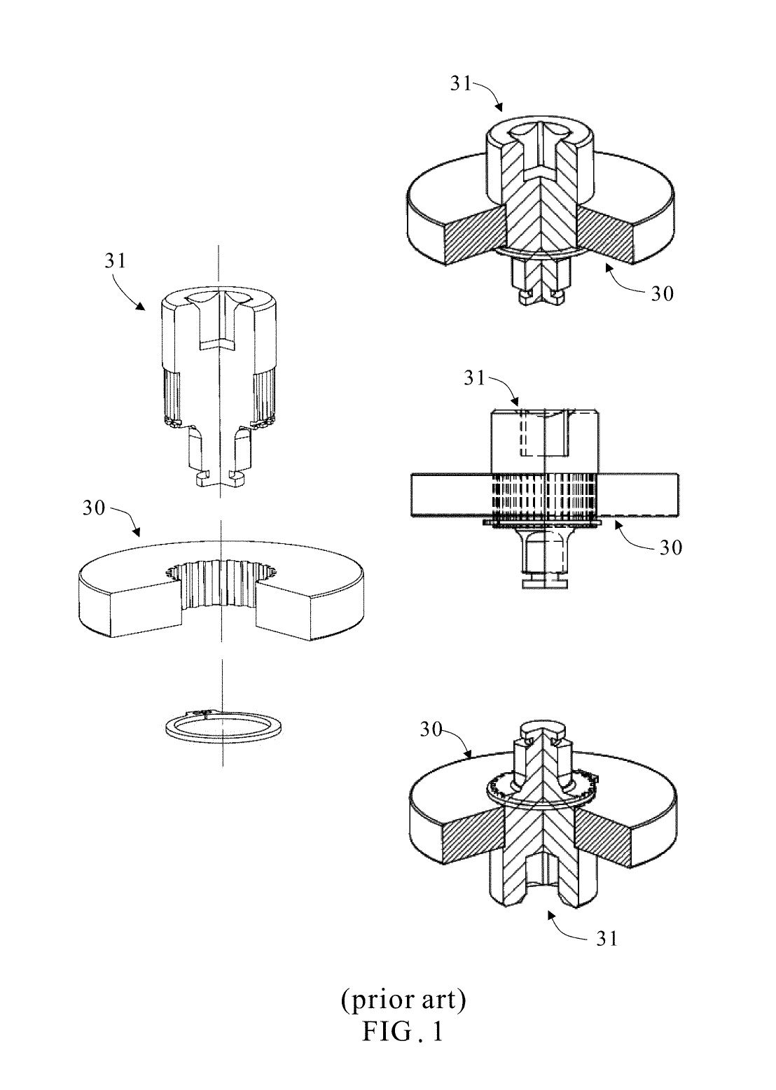

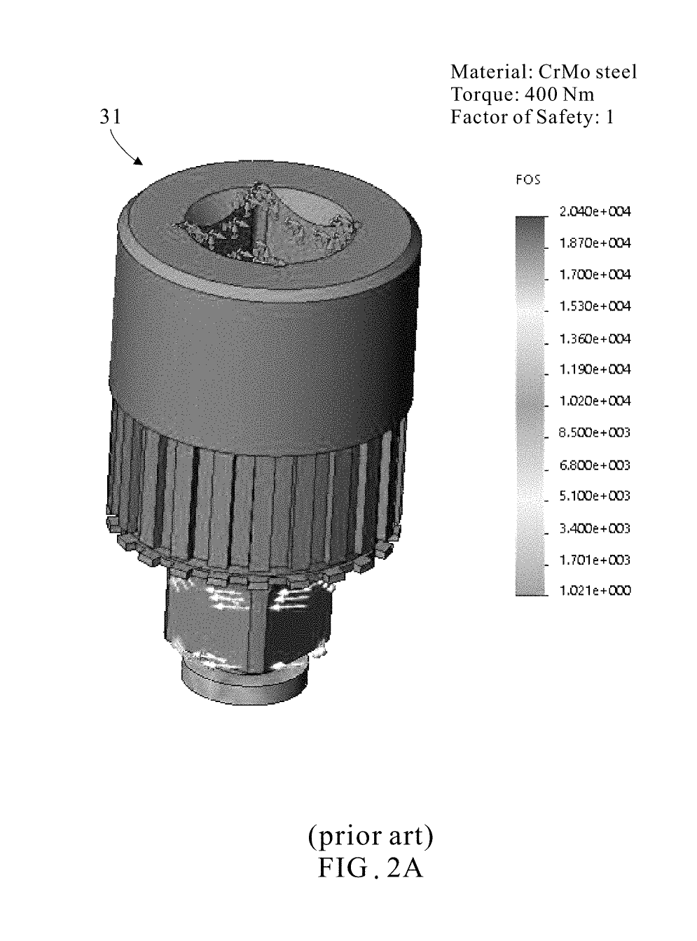

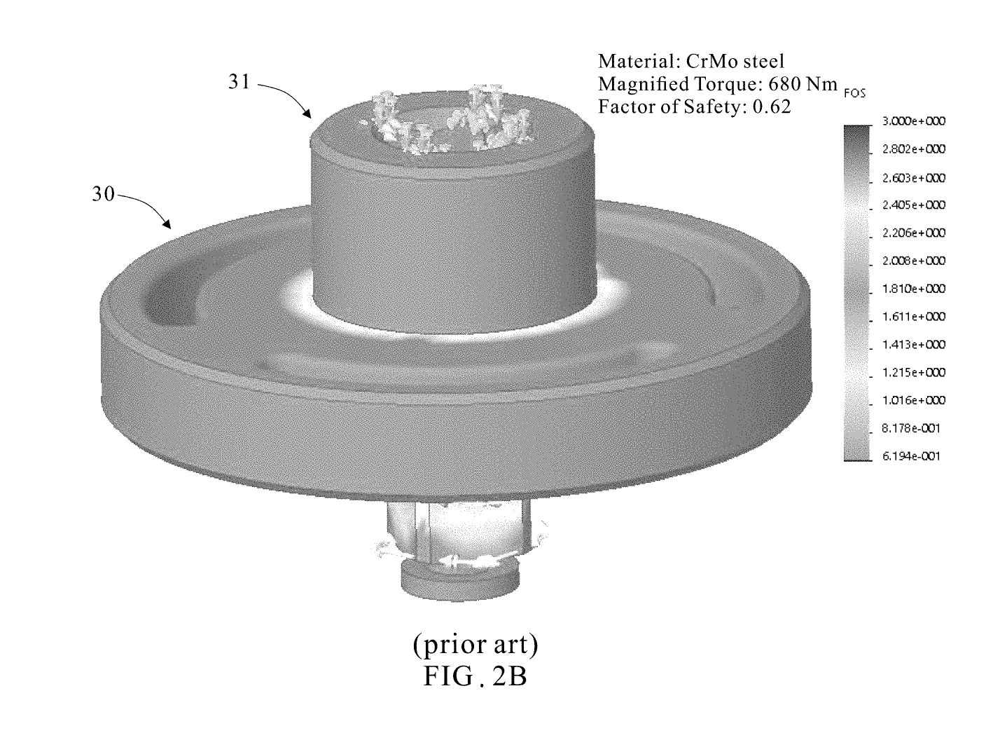

Please refer to FIG. 1, which includes different views showing a prior art rotary torque boosting device is assembled from a disc exterior inertia member 30 and a main body 31, and to FIGS. 2A and 2B, which show stress analyses conducted on the main body 31 of the rotary torque boosting device of FIG. 1 before and after the main body 31 is subjected to a magnified torque. In FIG. 2A, when the main body 31 without the disc exterior inertia member 30 is subjected to a torque of 400 Newton-meter (Nm), the factor of safety (FoS) thereof is as high as 1.0. In FIG. 2B, when the main body 31 with the disc inertia member 30 assembled thereto is rotating, the rotary inertia thereof increases, which leads to increasing output torque. However, when the output torque reaches up to 680 Nm, the FoS of the main body 31 is lower to only 0.62.

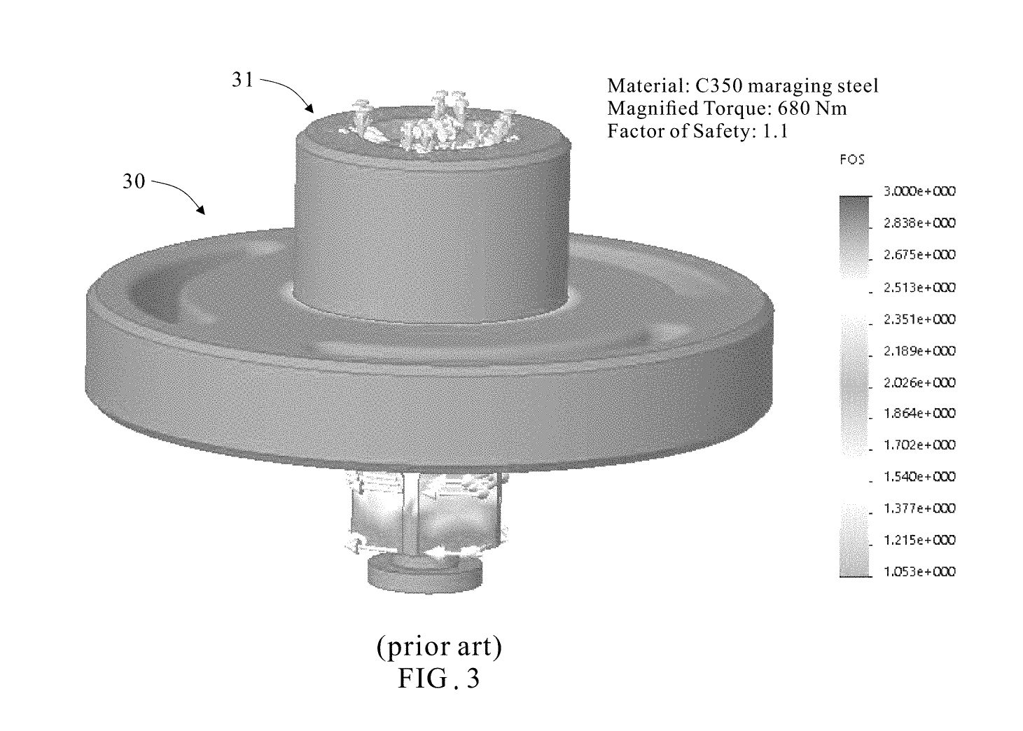

FIG. 3 shows a stress analysis conducted on the main body 31 of another conventional rotary torque boosting device, which is structurally similar to that shown in FIG. 2B but the main body 31 thereof is manufactured using a special high-strength steel material. According to the stress analysis, when the high-strength main body 31 with the disc exterior inertia member 30 assembled thereto is rotating and the output torque thereof reaches up to 680 Nm, the FoS of the main body 31 is as high as 1.1. However, the special high-strength steel material will increase the manufacturing cost of the rotary torque boosting device and forms a big hindrance to the commercialization thereof. Therefore, it is not recommended using a main body made of a high-strength steel material.

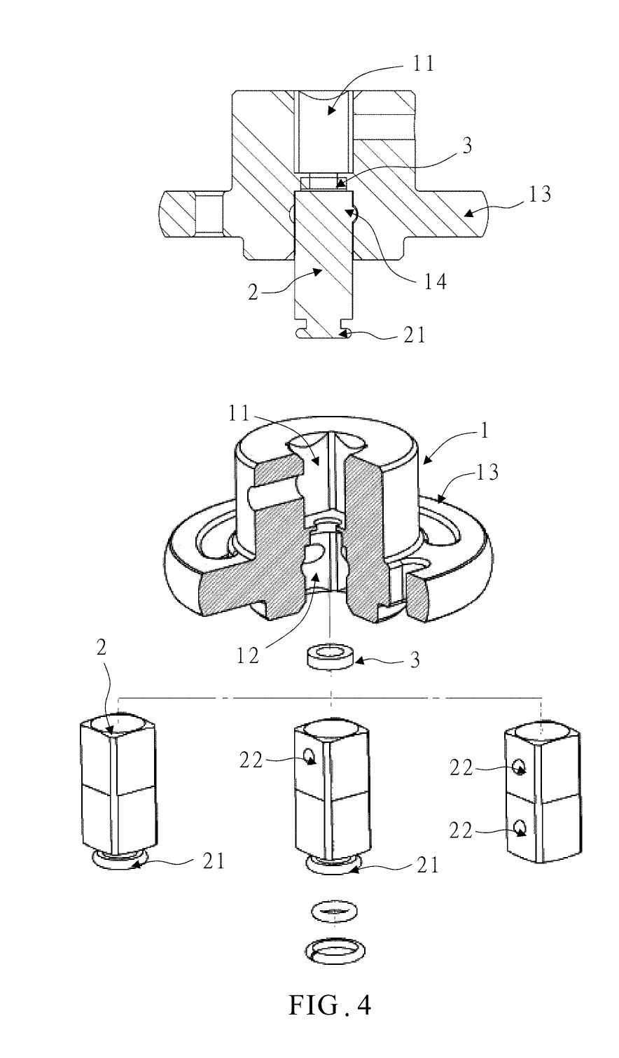

Please refer to FIG. 4, which shows assembled sectional view and exploded cutaway view of an improved rotary torque boosting device according to a preferred embodiment of the present invention. As shown, the improved rotary torque boosting device in FIG. 4 includes a main body 1, a driving anvil 2, and a magnetic unit 3. The main body 1 includes an input member 11 having an input recess for coupling with an output member of a power impact torque tool, and an output member 12 having an output recess sized and shaped to match those of the driving anvil 2 for elastically receiving the driving anvil 2 therein. The rotary torque boosting device of the present invention further includes an inertia flange 13 that is radially outward extended from and coaxial with the main body 1. The inertia flange 13 can be integrally formed using the same material as the main body 1. The magnetic unit 3 is attached to an inner bottom of the output recess of the output member 12 for magnetically attracting the driving anvil 2 thereto. The output member 12 is provided on around an inner wall surface of the output recess near the inner bottom thereof with an inner retaining groove 14 for engaging with at least one ball retainer 22 or elastic retaining device (not shown) that is provided on the driving anvil 2 at a position corresponding to the inner retaining groove 14, so as to avoid undesired separation of the driving anvil 2 from the output recess of the output member 12.

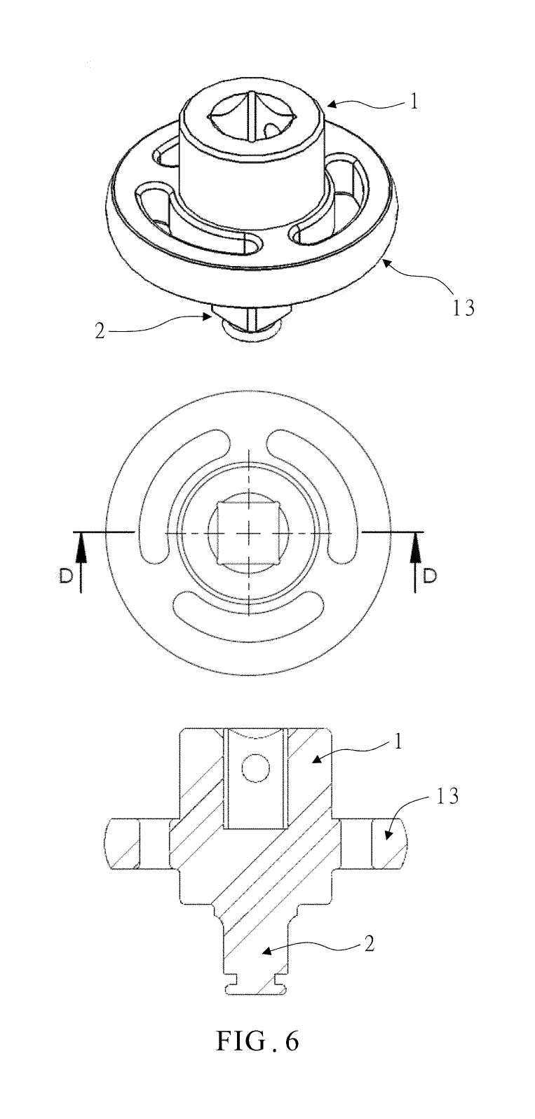

The axially extended input member 11 located at an end of the main body 1 can be differently sized and shaped to match the output member of the power impact torque tool (not shown) to be used with, and the output member 12 located at the other end of the main body 1 can also be differently sized and shaped to match the driving anvil 2 to be used with. An output member of the driving anvil 2 is sized and shaped corresponding to a socket (not shown) that is to be used with the driving anvil 2. The inertia flange 13 can be integrally formed using the same material as the main body 1, and the inertia flanges 13 can be coaxially assembled to or coaxially integrally formed with the main body 1, depending on actual need in use. According to another embodiment of the rotary torque boosting device of the present invention, as shown in FIG. 6, the inertia flange 13, the main body 1 and the driving anvil 2 can be coaxially integrally formed with one another. According to an operable embodiment of the present invention, depending on the magnitude of torque that can be magnified by the inertia flange 13, the driving anvil 2 can be manufactured using a material having a strength grade higher than that of the main body 1, and differently sized inertia flanges 13 can be used with differently configured driving anvils 2 in different combinations. According to another operable embodiment of the present invention, the inertia flange 13 can be integrally formed with the driving anvil 2. The magnetic unit 3 can be bonded to the inner bottom of the output recess of the output member 12 of the main body 1 for magnetically attracting the driving anvil 2 thereto.

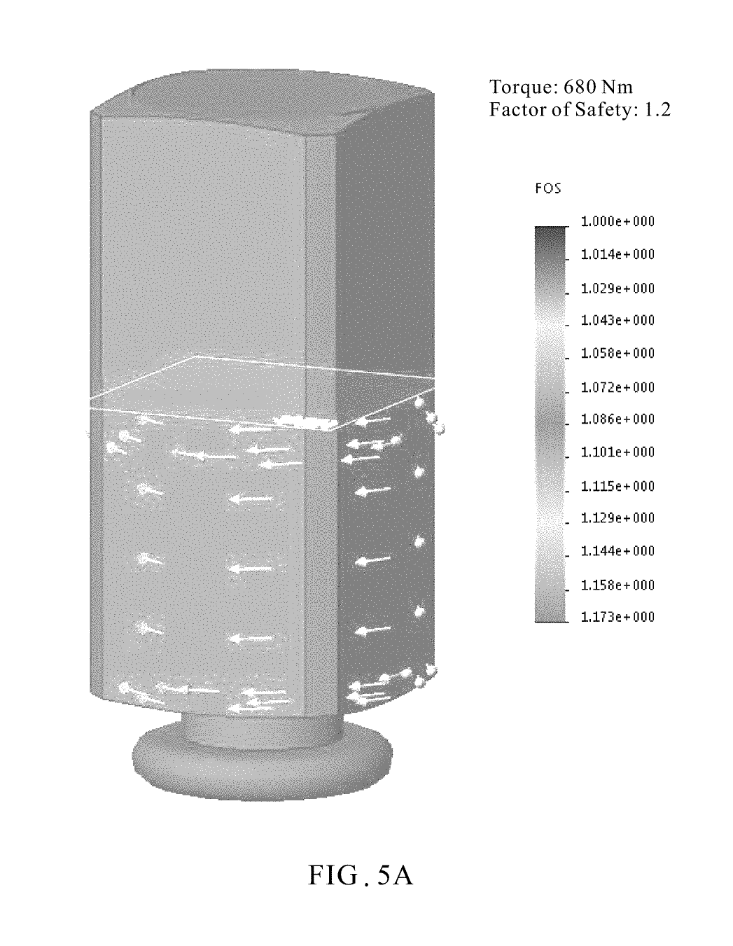

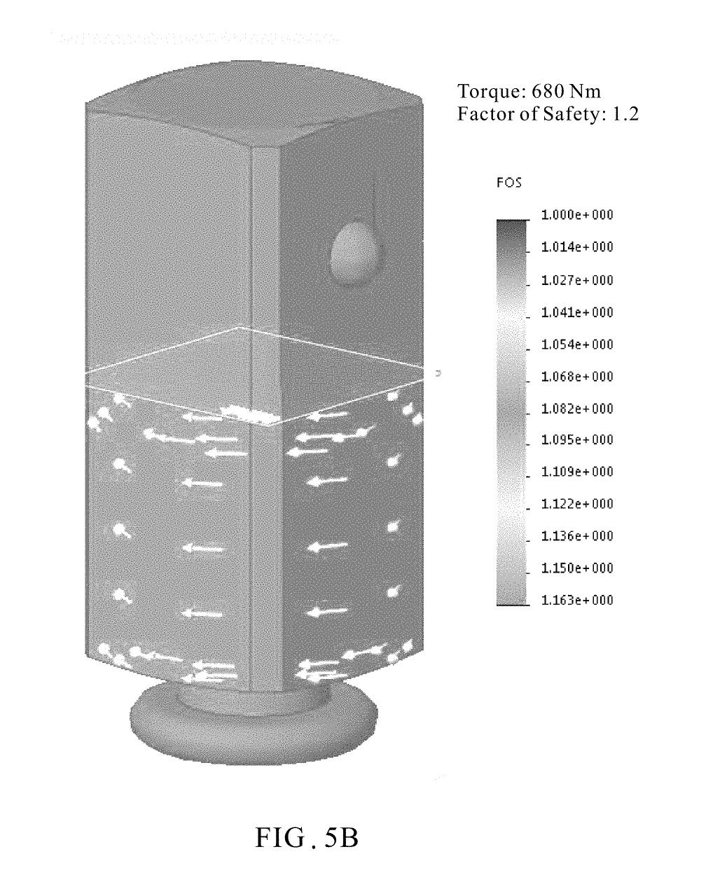

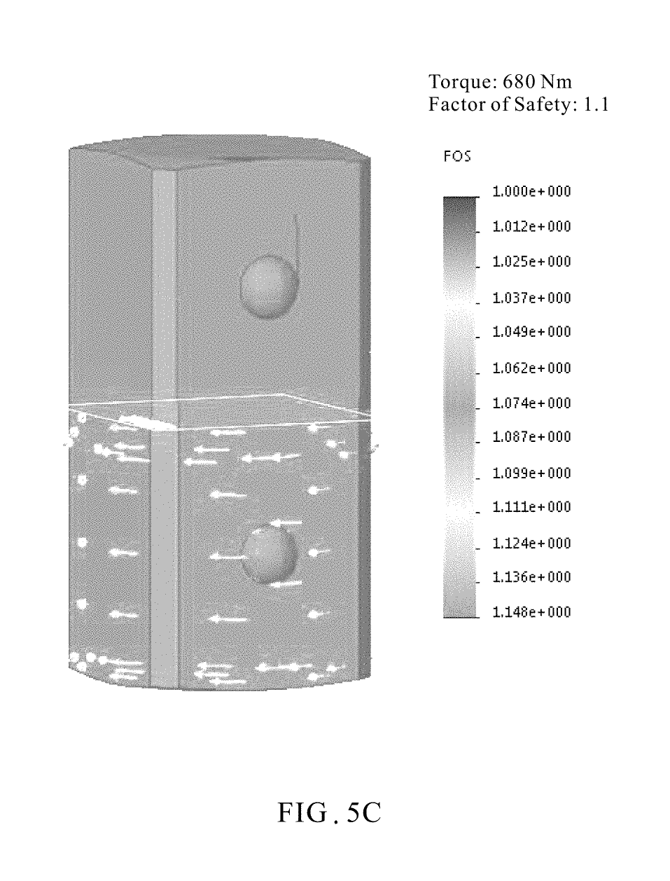

FIGS. 5A to 5C show stress analyses conducted on differently structured driving anvils 2 for the rotary torque boosting device of FIG. 4 when the driving anvils 2 are respectively subjected to a magnified torque up to 680 Nm. In FIG. 5A, the driving anvil 2 undergone the stress analysis has an upper end in contact with the magnetic unit 3 and a lower end formed with a retaining groove 21 (see FIG. 4), in which an elastic retaining device (not shown) is received to prevent the driving anvil 2 from easily separating from the socket connected thereto and to ensure the driving anvil 2 is stably held to the socket while allowing convenient replacement thereof. In FIG. 5B, the driving anvil 2 undergone the stress analysis is provided on one side surface near an upper end thereof with one ball retainer 22 (see FIG. 4), which has a bottom elastically supported by one or more springs. When the driving anvil 2 is inserted into the output member 12 of the main body 1 with the ball retainer 22 engaging with the inner retaining groove 14 formed in the output recess of the output member 12 of the main body 1, the driving anvil 2 can be stably held to the position inserted in the output member 12 without being easily separated from the main body 1 while allowing convenient replacement thereof. Further, the driving anvil 2 in FIG. 5B, similar to the driving anvil 2 in FIG. 5A, has a lower end provided with a retaining groove for receiving an elastic retaining device (not shown), which prevents the driving anvil 2 from easily separating from the socket connected thereto. In FIG. 5C, the driving anvil 2 undergone the stress analysis is provided on one side surface near an upper end thereof with one ball retainer 22 (see FIG. 4), which has a bottom elastically supported by one or more springs and is adapted to engage with the inner retaining groove 14 formed in the output recess of the output member 12 of the main body 1. The driving anvil 2 in FIG. 5C is further provided on one side surface near a lower end thereof with another ball retainer 22 (see FIG. 4), which also has a bottom elastically supported by one or more springs and is adapted to prevent the driving anvil 2 from easily separating from the socket connected thereto. Therefore, the driving anvil 2 can be stably held to the main body 1 while allowing convenient replacement thereof. The above three driving anvils 2 are respectively manufactured using a special high-strength steel for inserting into a conventional alloy-steel-made main body 1 that is usually used with most impact sockets. When the main body 1 having the inertia flange 13 rotates and the output torque increases up to 680 Nm, the FoS of all these three types of driving anvils 2 are no less than 1.1.

FIG. 6 shows another embodiment of the rotary torque boosting device according to the present invention. In this embodiment, the main body 1, the inertia flange 13 and the driving anvil 2 of the rotary torque boosting device are completely integrally formed with one another. For the integrally formed rotary torque boosting device of the present invention to be more practical for use, it has to be manufactured using a special high-strength steel material to have a FoS higher than 1. However, the high manufacturing cost thereof is still an important factor to be considered.

The present invention has been described with some embodiments thereof and it is understood that these embodiments are only illustrative and not intended to limit the present invention in any way and many changes and modifications in the described embodiments can be carried out without departing from the scope and the spirit of the invention that is intended to be limited only by the appended claims.

What is claimed is:

1. A rotary torque boosting device, comprising a main body and a driving anvil;
the main body including an inertia flange, an input member and an output member; the inertia flange being selectively assembled to or integrally formed with the main body; the input member of the main body being connectable to an output member of a power impact tool; and the output member of the main body having an output recess; and
the driving anvil being selectively fitted in the output recess of the output member of the main body to be conveniently removable from the output recess for replacement and being manufactured to match sizes and shapes of different sockets to be connected thereto, enabling the rotary torque boosting device to be flexibly, economically and effectively used in bolt tightening and loosening operations with a magnified rotary torque.

2. The rotary torque boosting device as claimed in claim 1, wherein the input member of the main body can be differently sized and shaped to match those output member of the power impact tool to be used therewith.

3. The rotary torque boosting device as claimed in claim 1, wherein the output recess of the output member of the main body can be differently sized and shaped to match those of the driving anvil to be fitted therein.

4. The rotary torque boosting device as claimed in claim 1, wherein the driving anvil is manufactured using a high-strength steel material selected according to a magnitude of torque that can be magnified by the inertia flange, and can be differently sized and shaped to match sizes and shapes of the sockets to be used therewith; and wherein the driving anvil is assembled to the main body and coaxial with the inertia flange.

5. The rotary torque boosting device as claimed in claim 1, wherein the inertia flange can be selectively coaxially assembled to or integrally formed with the main body.

6. The rotary torque boosting device as claimed in claim 5, wherein the inertia flange, the main body and the driving anvil are integrally coaxially formed with one another.

7. The rotary torque boosting device as claimed in claim 1, further comprising a magnetic unit; and the magnetic unit being bonded to the inner bottom of the output recess of the output member of the main body for magnetically attracting the driving anvil thereto to prevent separation of the driving anvil from the main body during operation and to allow easy replacement of the driving anvil.

8. The rotary torque boosting device as claimed in claim 1, wherein the output member of the main body is provided on around an inner wall of the output recess near the inner bottom thereof with an inner retaining groove for engaging with at least one ball retainer or elastic retaining device that is provided on the driving anvil, so as to prevent separation of the driving anvil from the main body during operation and to allow easy replacement of the driving anvil.
